(19) United States
(12) Patent Application Publication
(10) Pub. No.: US 2002/0131744 A1
(43) Pub. Date: Sep. 19, 2002

(54) Optical waveguide structure

(75) Inventors: Ivan Evans, Oxford (GB); Arnold Peter Roscoe Harpin, Boars Hill (GB)

Correspondence Address: FLESHNER & KIM, LLP, P.O. Box 221200, Chantilly, VA, 20153-1200, US

(73) Assignee: Bookham Technology plc

(21) Appl. No.: 09/855,525

(22) Filed: May 16, 2001

(30) Foreign Application Priority Data
Mar. 16, 2001 (GB) 0106743.8

(51) Int. Cl. G02B 6/10

(52) U.S. Cl. 385/129

(57) ABSTRACT

An optical waveguide structure formed on an optical chip comprising a first waveguide layer 3 of a first material supported on a substrate 7 and a second waveguide layer 6 of a second material supported on the first waveguide layer 3. The first waveguide layer 3 is separated from the substrate 7 by an optical confinement layer 8 and the second waveguide layer 6 is separated from the first waveguide layer 3 by an etch-stop layer 9. The etch-stop layer 9 is thin compared to the thickness of the first waveguide layer 3 and/or the second waveguide layer 6 and is of a material which enables it to act as an etch-stop when features are etched in the second waveguide layer 6.)

This invention relates to an optical waveguide structure formed on an optical chip and to a method of making the structure and, in a particular embodiment, to a tapered waveguide structure and a method of making the same.

Problems are currently experienced in fabricating integrated optical waveguide structures having features at two levels in the structure with the desired accuracy. As the overall dimensions of the structure increase, particularly in the depth dimension, i.e. perpendicular to the plane of the chip on which the structure is formed, difficulties arise due to the increased depth of etches required to fabricate features, particularly when these are 10 microns or more below the surface of the chip. Such dimensions are required when it is desired to match the size of an integrated optical waveguide with that of an optical fibre to which the waveguide is to be optically coupled.

Various ways of overcoming these difficulties are being proposed and the present invention relates to one type of structure and to a method of making the same which aims to reduce or overcome these problems.

According to a first aspect of the invention, there is provided on optical waveguide structure comprising a first waveguide layer of a first material supported on a substrate and a second waveguide layer of a second material supported on the first waveguide layer, the first waveguide layer being separated from the substrate by an optical confinement layer and the second waveguide layer being separated from the first waveguide layer by an etch-stop layer, the etch-stop layer being thin compared to the thickness of the first waveguide layer and/or the second waveguide layer and being of a material which enables it to act as an etch-stop when features are etched in the second waveguide layer.

According to a second aspect of the invention, there is provided a method comprising the steps of:

forming a structure comprising a first waveguide layer of a first material supported on a substrate and a second waveguide layer supported on the first waveguide layer, the first waveguide layer being separated from the substrate by an optical confinement layer and the second waveguide layer being separated from the first waveguide layer by an etch-stop layer;

etching features in the first waveguide layer; and

etching features in the second waveguide layer using an etchant which selectively etches the second material compared to the material of the etch-stop layer.

Preferred and optional features of the invention will be apparent from the following description and from the subsidiary claims of the specification.

References to the ‘height’ or the ‘thickness’ of layers described herein are both to be interpreted as referring to the dimension perpendicular to the plane of a chip or wafer on which the structure is formed.

The invention will now be further described, merely by way of example, with reference to the accompanying drawings, in which;

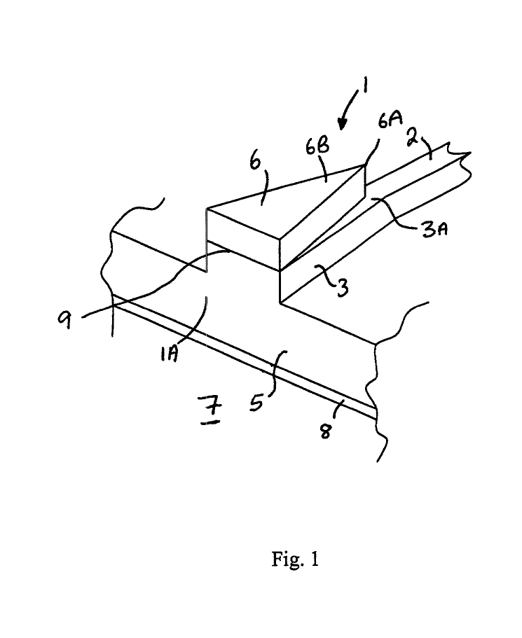

FIG. 1 is a perspective view of a first embodiment of an integrated optical waveguide structure according to the first aspect of the invention;

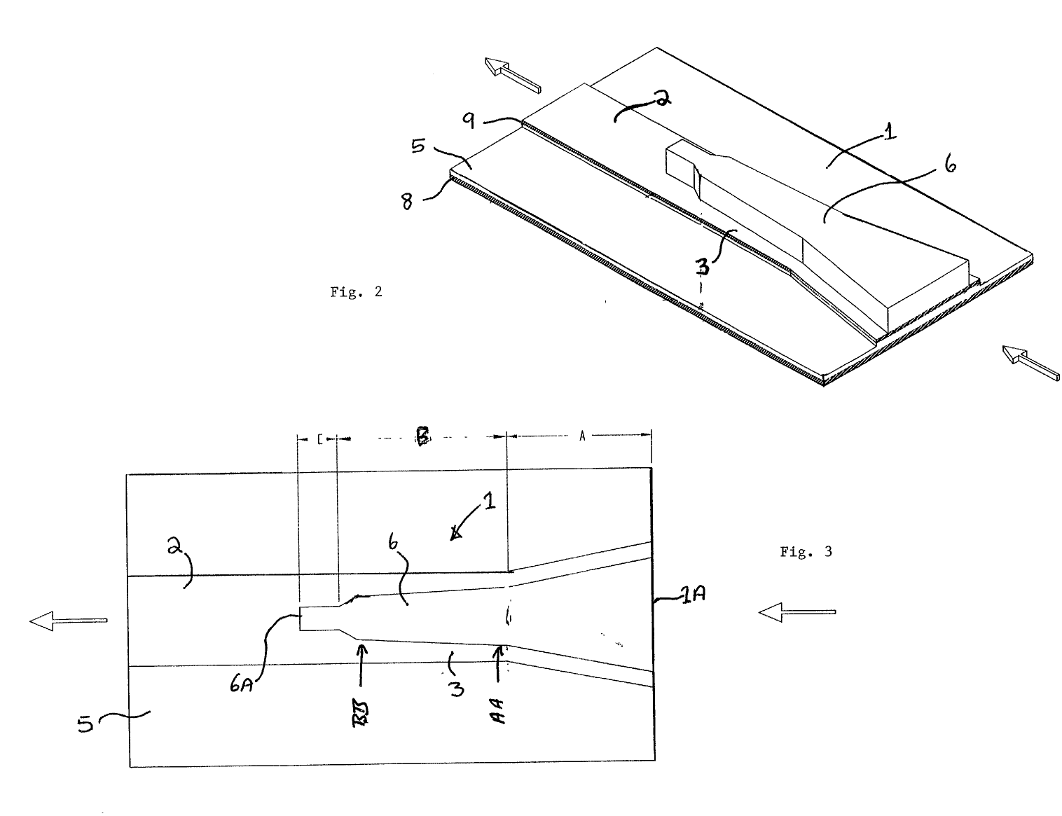

FIG. 2 is a perspective view of a second embodiment of an integrated optical waveguide structure according to a first aspect of the invention;

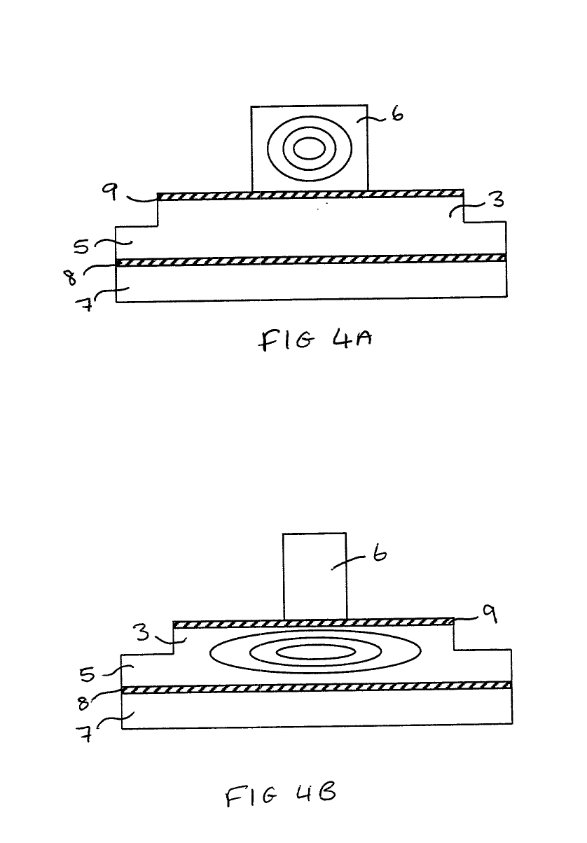

FIG. 3 is a plan view of the structure as shown in FIG. 2;

FIG. 4A is a cross sectional view taken on line A-A of FIG. 3; and

FIG. 4B is a cross sectional view taken on line B-B of FIG. 3.

FIG. 1 shows a perspective view of a tapered waveguide structure similar to that described in U.S. Pat. No. 6,108,478, the disclosure of which is incorporated herein.

This structure comprises a tapered waveguide 1 which provides a tapered coupling between a large end 1A thereof, which may be 10 microns or more high, and a smaller waveguide 2, typically 1 to 6 microns high. The structure comprises a rib waveguide 3, formed at a first level in a silicon layer 5, the rib waveguide 3 tapering laterally, i.e. in a direction perpendicular to the optical axis thereof but parallel to the plane of the chip, from the wide end 1A of the structure to a narrow end which leads to the smaller waveguide 2, and a wedge-shaped component 6, which also tapers laterally from the wide end 1A to a narrow end 6A, formed on the rib waveguide 3. The silicon layer 5 is preferably supported on a substrate 7 (which may also be of silicon) but separated therefrom by an oxide layer 8 (typically silicon dioxide), i.e. as in a silicon-on-insulator (SOI) chip, the thickness of which is typically in the range of 0.05 to 3 microns. The oxide layer 8 serves as a lower optical confinement layer. As described in U.S. Pat. No. 6,108,478, an optical mode received in the wide end 1A of the tapered waveguide 1, e.g. from an optical fibre (not shown), is coupled by the tapering structure into a smaller waveguide 2 at the narrow end of the taper. This is achieved by the lateral tapering of the rib waveguide 3 which gradually reduces the width of the optical mode therein and the lateral tapering of the wedge-shaped portion 6 which gradually transfers the optical mode input at the wide end 1A of the taper down into the waveguide 3 beneath the wedge-shaped portion 6.

As mentioned above, the structure described in U.S. Pat. No. 6,108,478 can be difficult to fabricate accurately as a deep etch is required to form the features of the rib waveguides 2,3 which may lie 10 microns or more beneath the surface of the chip (the surface of the chip being at the level of the upper surface of the wedge-shaped portion 6). The oxide layer 8 accurately defines the position of the base of the structure. However, if deep etches are used to form the rib waveguide 3, the position of the upper surface 3A of the waveguide 3 cannot be accurately defined due to fabrication tolerances and this can cause significant deterioration in the performance of the device.

To overcome this difficulty, the structure described herein is provided with a second oxide layer 9 between the rib waveguide 3, which is formed at a first lower level in the device, and the wedge-shaped portion 6, which is formed at a second, higher level in the device.

There are a variety of ways of fabricating a silicon chip having two such buried oxide layers 8,9 and these will be described further below.

The advantage of providing the second oxide layer 9 is that features in the first level, i.e. beneath the second oxide layer 9, and features in the second level, i.e. above the second oxide layer 9, can be fabricated independently of each other so the fabrication of features in one level does not prejudice the accuracy with which features in the other level can be formed. Moreover, in the embodiment illustrated, the vertical dimension, i.e. in a direction perpendicular to the plane of the chip, of the rib waveguide 2,3 formed in the lower level is precisely determined by the distance between the two oxide layers 8,9.

Furthermore, the second oxide layer 9 can be used as an etch-stop so the position of the lower side of features formed in the second, upper layer of the device can be precisely determined, relative to the lower oxide layer 8. The position of the upper side 6B of features formed in the second, upper layer will be determined by the process used to fabricate those features and/or the method by which the upper silicon layer 5 or the chip having two buried oxide layers 8,9 is formed but both of these processes enable the positions of the upper side 6B of the features to be determined with sufficient accuracy.

One masking step can thus be used to form features in the layer above the second oxide layer 9 and a second masking step used to form features in the layer below the second oxide layer 9. These two masking steps can be carried out in any order.

It will be appreciated that to act as an etch-stop a layer of material needs to be relatively resistant to an etch used to fabricate features in the layer above the etch-stop layer; an etch selectivity of at least 15:1 between the two materials is preferred. Silicon dioxide is a convenient etch-stop material as it is easily formed, e.g. by oxidation of the silicon or by implantation (as described further below), and is only etched very slowly by etchants commonly used to etch features in a silicon layer.

FIGS. 2 and 3 show perspective and plan views, respectively, of a further embodiment of a waveguide structure according to the present invention. In this example, the wedge-shaped portion 6 has a height of about 4.3 microns and the waveguide 3 has a height of about 1.5 microns. This is similar to the structure described above in relation to FIG. 1, except that the tapering section of rib waveguide 3 is slightly wider than the wedge-shaped portion 6 and the wedge-shaped portion is divided into three regions A, B and C: region A being rapidly tapered, e.g. at an angle in the range 0.05 to 3 degrees, to the optical axis, from a width of about 4 microns to a width of about 1.6 microns; region B being gradually tapering, e.g. at an angle of around 0.005 degrees to 1 degree, from a width of about 1.6 microns to a width of about 1.4 microns, and terminating in a short, rapidly tapering section e.g. tapering at an angle in the range 0.05 to 3 degrees; and region C being a narrow portion where the wedge-shaped portion 6 terminates. Region A is the region in which the optical mode is transmitted primarily in the upper layer of the device above the second oxide layer 9, region B is the region in which the optical mode in the upper layer interacts strongly with the optical mode in the lower layer and region C is the region in which the optical mode is transmitted primarily in the lower layer of the device. Only the region B need be tapered gradually, and once the optical mode has transferred to the lower layer, the wedge-shaped portion 6 may terminate. It need not terminate at a point but the width of the narrow section C is preferably 0.5 microns or less.

The form of waveguide shown in FIGS. 2 and 3 differs from that of known tapered structures, such as described in U.S. Pat. No. 6,108,478 (which tend to have a more uniform taper throughout their length) as a consequence of the fact that the optical modes in the upper and lower parts of the structure are more de-coupled towards the wide and narrow ends of the taper due to the presence of the second oxide layer 9.

FIGS. 4A and 4B show cross-sections of the device shown in FIG. 3 along line AA and B-B, respectively.

The structures illustrated in FIGS. 1-4 operate in a substantially similar manner to that described in U.S. Pat. No. 6,108,478. The second oxide layer 9 should be thick enough (in a direction perpendicular to the plane of the chip on which the structure is formed) to form an effective etch-stop but otherwise should be as thin as possible so as to minimise its influence on the optical mode carried by the tapered waveguide. If it is sufficiently thin, it is found that the oxide layer 9 has little effect upon the optical mode carried by the tapered waveguide but, compared to the structure described in U.S. Pat. No. 6,108,478, the optical mode tends to be confined to the part of the wedge-shaped portion 6 above the oxide layer 9 at the wide end 1A thereof as shown in FIG. 4A. As the width of the wedge-shaped portion 6 reduces, the effective refractive index of the optical mode in the waveguide above the second oxide layer 9 reduces until it becomes similar to that of an optical mode in the rib waveguide 3 beneath the oxide layer 9. Power transfer between the wedge-shaped portion 6 and the waveguide 3 then occurs until, towards the narrow end of the wedge-shaped portion 6, the optical mode is principally carried by the waveguide 3 beneath the oxide layer 9 as shown in FIG. 4B.

In the portion of the tapered waveguide where this power transfer occurs, the taper is preferably as gradual as possible to provide an adiabatic transfer from the upper layer of the waveguide structure to the lower layer of the waveguide structure.

The second oxide layer 9 should have a sufficient thickness to function as an effective etch step but not be so thick as to significantly affect the optical coupling between the upper and lower portions of the structure and preferably has a thickness in the range of 0.005 to 0.4 microns and most preferably in the range 0.02 to 0.1, e.g. around 0.05 microns.

Due to the presence of the second oxide layer 9, it is found that the tapered waveguide structure needs to be longer than a corresponding structure manufactured without the second oxide layer as described in U.S. Pat. No. 6,108,478, as the taper needs to be even more gradual to avoid or minimise the optical mode oscillating or beating between the upper and lower portions of the tapered structure and because the second oxide layer 9 reduces interaction between the upper and lower portions of the structure. A typical tapered structure formed by the method described herein may be 15-50 mm in length, which is up to ten times longer than a conventional taper although optimisation of the design should lead to reduction of length.

Typically, the portion of the waveguide where the power transfer occurs is tapered at an angle of 1 degree or less to the optical axis of the waveguide and preferably at an angle of 0.005 degrees or less.

A silicon chip having two buried oxide layers may be formed by a variety of methods:

i) Starting with a conventional SOI chip, the second oxide layer may be fabricated by implantation of oxygen, known as SIMOX (separation by Implantation of Oxygen) fabrication, although care may need to be taken to ensure this does not disturb the first oxide layer too much.

Alternatively, the following bonding techniques may be used, starting with an SOI chip (which may itself be made either by the SIMOX process or a bonding technique such as that described in U.S. Pat. No. 5,371,037):

ii) A silicon layer may be bonded to an oxidised SOI wafer and then etched back to the required thickness, the second oxide layer being formed by the oxide layer on the surface of the initial SOI wafer. This bonding step may take place before or after fabrication of features in the layer of silicon which forms the lower layer of silicon in the final structure. The silicon layer may be bonded to the SOI wafer by a direct bonding technique.

iii) A silicon layer may be bonded to an oxidised SOI wafer as in (ii) above but reduced to the required thickness by a cleaving technique such as that described in U.S. Pat. No. 5,985,742 (known as a “smart cut” process).

The tapered waveguide structure described above may be used to couple waveguides and/or optical fibres of differing sizes, e.g. tapering from 4.3 microns to 1.5 microns, or tapering from 10 microns to 0.5 microns. The height of the waveguide at the wide end thereof may be in the range 2 to 14 microns and the height of the waveguide at the narrow end may be in the range 0.3 to 6 microns. The structure may also be used in either direction, i.e. to couple light from a wide waveguide into a narrower waveguide or from a narrow waveguide into a wider waveguide.

The method described above thus enables waveguide structures coupling two or more layers, such as the tapered waveguide described above, to be fabricated with greater accuracy by avoiding the need for deep etches and avoiding the need to first fabricate the lower layer of the device and then use epitaxial regrowth to provide a further layer in which the upper layer of the device can be formed.

Other etch-stop materials may be used in place of the second oxide layer 9, e.g. silicon nitride. The etch-stop layer should preferably have a refractive index close to that of silicon, or whatever material is used above and/or below the layer, and have a high etch selectivity relative to those materials. However, in practice, when materials such as silicon oxide or silicon nitride are used for the etch-stop, in conjunction with silicon, it may be difficult to satisfy both these requirements, in which case, the thickness of the layer should be kept as small as possible, as described above, to allow coupling between the upper and lower portions of the structure.

Although the material used above and below the etch-stop layer is usually the same, e.g. silicon, as in the example given above, different materials may also be used, e.g. any combination of silicon, gallium arsenide, germanium, silicon carbide, indium phosphide, silicon nitride and silicon oxynitride. Whilst this may negate the need for the etch-stop layer to provide the required etch-selectivity (if the different materials themselves are etched at significantly different rates by the chosen etchant), the process nevertheless provides a convenient way of joining two such dissimilar materials. It can be difficult to deposit one waveguide material directly onto another due to mis-matches of their structures which lead to a poor bonding therebetween. However, the provision of a thin layer, e.g. of oxide or nitride, between the layers provides a convenient way of joining or hybridising two dissimilar materials as it is often easier to bond a semiconductor material to a thin oxide or nitride layer than it is to bond it to another semiconductor layer. Thus, the structure used would be similar to that described above except that the materials on either side of the second oxide layer are not the same as each other. As before, the second oxide layer should be as thin as possible to allow coupling between the upper and lower portions of the structure.

It will be appreciated that the second oxide layer (or what other material is used) still functions as an etch-stop layer in this arrangement even though the etch properties of the material on either side of the layer are also different.

The two different materials used above and below the etch step layer should preferably have similar refractive indexes although, if they differ, it is possible to adjust them, e.g. by doping one or more of the materials.

1. An optical waveguide structure formed on an optical chip comprising a first waveguide layer of a first material supported on a substrate and a second waveguide layer of a second material supported on the first waveguide layer, the first waveguide layer being separated from the substrate by an optical confinement layer and the second waveguide layer being separated from the first waveguide layer by an etch-stop layer, the etch-stop layer being thin compared to the thickness of the first waveguide layer and/or the second waveguide layer and being of a material which enables it to act as an etch-stop when features are etched in the second waveguide layer.

2. A structure as claimed in claim 1 comprising a first optical feature in the first waveguide layer and a second optical feature in the second waveguide layer, the first and second features being arranged to optically interact with each other.

3. A structure as claimed in claim 2 in which the first feature comprises an optical waveguide.

4. A structure as claimed in claim 3 in which the waveguide is a rib waveguide having side faces extending substantially perpendicular to the plane of the chip and a top face joining the side faces.

5. A structure as claimed in claim 3 or 4 in which the second feature comprises a tapered waveguide portion.

6. A structure as claimed in claim 5 in which the second feature comprises a laterally tapering waveguide portion formed on the top face of the rib waveguide with the etch-stop layer therebetween.

7. A structure as claimed in any preceding claim in which both the first material and the second material are silicon.

8. A structure as claimed in any preceding claim in which the confinement layer is an oxide of the first material.

9. A structure as claimed in any preceding claim in which the etch-stop layer is an oxide of the first material.

10. A structure as claimed in any preceding claim in which the first waveguide layer has a thickness in the range of 0.2 to 6 microns.

11. A structure as claimed in any preceding claim in which the second waveguide layer has a thickness of at least 1 micron.

12. A structure as claimed in any preceding claim in which the combined thickness of the first and second waveguide layers is 10 microns or more.

13. A structure as claimed in any preceding claim in which the confinement layer has a thickness in the range 0.05 to 3 microns.

14. A structure as claimed in any preceding claim in which the second etch-stop layer has a thickness in the range 0.005 to 0.4 microns.

15. A structure as claimed in claim 6 or any claim dependent thereon in which the tapering waveguide tapers from a height of 2 to 14 microns at the wide end thereof to a waveguide having a height in the range 0.3 to 6 microns at the narrow end thereof.

16. A structure as claimed in claim 15 in which at least a major portion of the tapering waveguide tapers at an angle of 1 degree or less to the optical axis thereof, and preferably 0.005 degrees or less.

17. A structure as claimed in claim 16 in which a first portion of the tapering waveguide tapers at an angle in the range 0.05 to 3 degrees to the optical axis at one end of said major portion and a second portion of the tapering waveguide tapers at an angle of 0.05 to 3 degrees to the optical axis at the other end of said major portion.

18. An optical waveguide structure substantially as herein before described with reference to and/or as shown in one or more of the accompanying drawings.

19. A method of fabricating an optical waveguide structure on an optical chip comprising the steps of:
forming a structure comprising a first waveguide layer of a first material supported on a substrate and a second waveguide layer supported on the first waveguide layer, the first waveguide layer being separated from the substrate by an optical confinement layer and the second waveguide layer being separated from the first waveguide layer by an etch-stop layer;
etching features in the first waveguide layer; and
etching features in the second waveguide layer using an etchant which selectively etches the second material compared to the material of the etch-stop layer.

20. A method as claimed in claim 19 in which a first lithographic mask is used to define a first feature in the first waveguide layer and a second lithographic mask is used to define a second feature in the second waveguide layer.

21. A method as claimed in claim 19 or 20 for forming a structure as claimed in any of claims 1 to 18.

22. A method of fabricating an optical waveguide structure substantially as hereinbefore described with reference to one or more of the accompanying drawings.
